(19) United States
(12) Patent Application Publication
(10) Pub. No.: US 2023/0347465 A1
(43) Pub. Date: Nov. 2, 2023

(54) UNLOADING DEVICE AND UNLOADING METHOD FOR GANTRY-TYPE MACHINING CENTER BEAM GUIDE RAIL

(71) Applicant: Jilin University, Changchun (CN)

(72) Inventors: Chuanhai Chen, Changchun (CN); Zhifeng Liu, Changchun (CN); Jingyan Guo, Changchun (CN); Shang Chen, Changchun (CN); Tongtong Jin, Changchun (CN); Baobao Qi, Changchun (CN); Zhaojun Yang, Changchun (CN); Junqi Long, Changchun (CN); Zhijie Li, Changchun (CN); Chunlei Hua, Changchun (CN); Liang Zhang, Changchun (CN); Haoming Yan, Changchun (CN)

(21) Appl. No.: 18/346,876

(22) Filed: Jul. 5, 2023

Related U.S. Application Data
(63) Continuation of application No. PCT/CN2023/089659, filed on Apr. 21, 2023.

(30) Foreign Application Priority Data
Jul. 5, 2022 (CN) 202210792404.3

(51) Int. Cl. B23Q 41/08

(52) U.S. Cl. CPC B23Q 41/08; B23Q 2210/00

(57) ABSTRACT

An unloading device and an unloading method for a gantry-type machining center beam guide rail is disclosed, which is used to be installed on a sliding plate assembly, comprising a first booster mechanism and a second booster mechanism. When a worm rotates and drives a worm gear to rotate, an axial displacement can be generated by the worm gear along a worm gear shaft to push the retaining sleeve assembly, and an unloading force generated acts on a first mounting bracket. An unloading bolt of the second booster mechanism is connected with a press plate through threads, the unloading bolt is rotated to generate an axial displacement, and a second sliding block is pressed tightly against an unloading guide rail vertical surface by a second mounting bracket to generate an unloading force.

### TECHNICAL FIELD

The present invention relates to the technical field of machining centers of machine tools, and particularly relates to an unloading device and an unloading method for a gantry-type machining center beam guide rail.

### BACKGROUND

Large-scale gantry-type machining centers have an important position in the field of industrial manufacturing, especially in recent years, with the rapid development of China’s equipment manufacturing industry, the demand and technical requirements for this kind of machine tools are increasingly high in the market. A beam guide rail is a key component for ensuring the machining accuracy of a gantry-type machining center, and the guiding accuracy, the straightness, the stiffness and the wear resistance thereof have a significant influence on the machining quality. As the beam guide rail is affected by the gravity action of a sliding plate assembly, the surface of the guide rail is usually under large load, and wear becomes a key problem which must be considered in product design; an overturning trend is imposed on the beam guide rail by the gravity of the sliding plate assembly, and the straightness of the guide rail is also affected. Therefore, an unloading mechanism is usually involved to solve the problem of guide rail surface wear and ensure the straightness of the beam guide rail and the machining accuracy of a machine tool.

Common unloading modes of the beam guide rail include hydraulic unloading, mechanical unloading and pneumatic unloading, and the design of the magnitude of an unloading force provided by a booster mechanism often depends on engineering experience. However, for different types and different structures of guide rails and unloading schemes, no theoretical method is available for analyzing the unloading force, and the evaluation and optimization of the unloading schemes are even more difficult to carry out.

The existing unloading force design method is mainly based on the method described in Modern Practical Machine Design Manual. In order to avoid the moving part floating caused by excessive unloading ratio, a rough range of unloading factor a is given for different types of machine tools according to engineering experience. For example, in patent CN103286625B “Unloading Device for Machine Tool”, an adjusting nut is arranged in a booster mechanism of an unloading unit, and the deformation of an elastic part is changed by adjusting the nut, so that 80% of the self-weight of a sliding saddle is unloaded to a steel inlaid guide rail in the middle part of a beam.

However, the unloading scheme design method mainly relies on engineering experience, so the design result thereof has certain fuzziness and randomness, and lacks a scientific and reasonable theoretical basis; in the unloading force solving method, the influence of the sliding speed on the load-bearing condition of the guide rail is not considered, and no unloading force solving method for the working condition of a specific moving speed is provided; As a hard beam guide rail has a plurality of guide rail surfaces and a complicated stress condition, the actual load-bearing condition of each guide rail surface cannot be quantified by the existing unloading scheme design method.

Therefore, the problem to be urgently solved by those skilled in the art is how to provide an unloading device and an unloading method for a gantry-type machining center beam guide rail capable of ensuring the straightness of the beam guide rail and improving the machining accuracy of a machine tool.

### SUMMARY

In view of this, the present invention provides an unloading device and an unloading method for a gantry-type machining center beam guide rail to further ensure the straightness and bearing capacity of the beam guide rail.

To achieve the above purpose, the present invention adopts the following technical solution: an unloading device for a gantry-type machining center beam guide rail, which is used to be installed on a sliding plate assembly, wherein the sliding plate assembly is slidably connected with a beam guide rail of a gantry-type machining center, and the beam guide rail has an upper guide rail surface, lower guide rail surfaces, an unloading guide rail horizontal surface, an unloading guide rail vertical surface and pretightening guide rail surfaces; the unloading device comprises: a first booster mechanism, wherein the first booster mechanism comprises a worm, a worm gear gland, a worm gear shaft, a worm gear, a retaining sleeve assembly, a first mounting bracket and a first sliding block, the worm is horizontally and rotationally connected with the sliding plate assembly, the worm gear gland is fixed on the sliding plate assembly, a screw hole is formed in the worm gear gland, the top end of the worm gear shaft is connected in the screw hole through threads, the worm gear is fixed on the worm gear shaft and is engaged with helical teeth of the worm, a shaft hole is formed in the first mounting bracket, the bottom end of the worm gear shaft is slidably connected in the shaft hole, the retaining sleeve assembly is sheathed on the worm gear shaft, the retaining sleeve assembly is butted with the first mounting bracket, the first sliding block is installed on the first mounting bracket, and the first sliding block is slidably connected with the unloading guide rail horizontal surface;

A second booster mechanism, wherein the second booster mechanism comprises an unloading bolt, a second mounting bracket and a second sliding block, an unloading press plate is fixed on one side of the sliding plate assembly, the unloading bolt is horizontally connected with the unloading press plate through threads, a through hole is formed in the second mounting bracket, a shaft lever is coaxially fixed on one end of the unloading bolt, the shaft lever is fitted in the through hole, one end of the unloading bolt is butted with the second mounting bracket, the second sliding block is connected with the second mounting bracket, and the second sliding block is slidably connected with the unloading guide rail vertical surface.

The present invention has the following beneficial effects: the first booster mechanism uses the worm couple and the retaining sleeve assembly to realize the adjustment of a vertical unloading force; the rotation of the worm makes the helical teeth of the worm drive the worm gear to rotate; as the worm gear shaft is connected with the worm gear gland through threads, and the worm gear gland is fixed on the sliding plate assembly, an axial displacement can be generated during the rotation of the worm gear shaft to push the retaining sleeve assembly, and an unloading force generated by the retaining sleeve assembly acts on the first mounting bracket to make the first sliding block press down the unloading guide rail horizontal surface. The second booster mechanism is installed on the unloading press plate, the unloading bolt is connected with the unloading press plate through threads, an axial displacement is generated in the horizontal direction during the rotation of the unloading bolt, and the second mounting bracket is pushed by the unloading bolt to make the second sliding block pressed horizontally against the unloading guide rail vertical surface and generate an unloading force.

Preferably, the retaining sleeve assembly comprises a worm gear retaining sleeve and a disk spring, the worm gear shaft is a stepped shaft, the worm gear retaining sleeve and the disk spring are respectively sheathed on the peripheral side of the worm gear shaft, the top end of the worm gear retaining sleeve is butted with the shoulder of the worm gear shaft, the bottom end of the worm gear retaining sleeve is butted with the top end of the disk spring, and the bottom end of the disk spring is butted with the top end surface of the first mounting bracket.

Preferably, a mounting groove is formed in the bottom of one side of the unloading press plate, a threaded hole is horizontally formed in the unloading press plate corresponding to the bottom of the mounting groove, the unloading bolt is connected with a round nut, and the round nut is butted with the wall of the other side of the unloading press plate.

Preferably, the bottom end of the unloading press plate is horizontally and fixedly connected with a baffle plate, the second mounting bracket is slidably connected in the mounting groove, and the bottom end of the second mounting bracket is slidably connected with the baffle plate.

Preferably, the first sliding block and the second sliding block are rolling sliding blocks for machine tools.

Preferably, the outer sidewall of one end of the worm is fixedly connected with a fixed seat, a plurality of screw holes are formed in the fixed seat, the fixed seat is fixedly connected with the sliding plate assembly through screws to limit the rotation of the worm, and an inner corner blind hole which is convenient for driving the worm to rotate is formed in one end of the worm.

The present invention also discloses an unloading method for a gantry-type machining center beam guide rail, which uses the unloading device for a gantry-type machining center beam guide rail and comprises the following steps:
Step 1: dividing the guide rail surfaces on the beam guide rail into an upper guide rail surface, lower guide rail surfaces, an unloading guide rail horizontal surface, an unloading guide rail vertical surface and pretightening guide rail surfaces according to the actual engineering, wherein a guide rail surface which bears a load only playing a pretightening role and has no resistance to an overturning trend of the sliding plate assembly is regarded as a pretightening guide rail surface, and the upper guide rail surface, the lower guide rail surfaces, the unloading guide rail horizontal surface and the unloading guide rail vertical surface are regarded as main load-bearing guide rail surfaces, and establishing a stress balance equation for each main load-bearing guide rail surface;
$$\left\{\begin{matrix}\sum {F}_{X} = 0 \\ \sum {F}_{Y} = 0 \\ \sum \text{M} = 0\end{matrix}\right) \qquad \text{(1)}$$
Step 2: introducing a rotation angle α formed by the overturning effect of the sliding plate assembly, a vertical deformation δ of a plastic laminated surface, and coordinates of a rotation center, dividing distribution regions of the rotation center, and obtaining deformation compatibility equations based on a stressed area S of each main load-bearing guide rail surface;
$$\text{δ} = cos β α l \qquad \text{(2)}$$
$$\text{F} = cos β α l k S \qquad \text{(3)}$$
Assuming that the distance between the rotation center and the application point of a resultant force F on each main load-bearing guide rail surface is l, an included angle between a connecting line from the rotation center to a corresponding unloading application point of the unloading guide rail vertical surface and the horizontal direction is β, and the stiffness of a contact surface is k;
Step 3: taking the horizontal and vertical coordinates of the application point of the resultant force on each guide rail surface as boundaries to divide the surface into a plurality of rectangular regions, overturning the sliding plate assembly in a direction opposite to the position of the beam, judging the increasing and decreasing trend of the pressure of each guide rail surface compared with that when the sliding plate assembly is not overturned, analyzing the pressure variation trend of each guide rail surface when the rotation center is located in each rectangular region, selecting each rectangular region with the variation trend conforming to the actual situation as a possible distribution region of the rotation center, establishing a geometric equation for each possible distribution region, and establishing a mathematical model based on the deformation compatibility equations and the balance equations:
$$\left\{\begin{matrix}\sum {F}_{X} = 0 \\ \sum {F}_{Y} = 0 \\ \sum \text{M} = 0 \\ \left|sin {β}_{1} ⋅ {l}_{1} + {λ}_{1} ⋅ sin {β}_{2} ⋅ {l}_{2}\right| = {a}_{1} \\ \left|cos {β}_{1} ⋅ {l}_{1} + {ψ}_{1} ⋅ cos {β}_{2} ⋅ {l}_{2}\right| = {b}_{1} \\ ⋮ \\ \left|sin {β}_{n - 3} ⋅ {l}_{n - 3} + {λ}_{n - 2} ⋅ sin {β}_{n - 2} ⋅ {l}_{n - 2}\right| = {a}_{n - 3} \\ \left|cos {β}_{n - 3} ⋅ {l}_{n - 3} + {ψ}_{n - 2} ⋅ cos {β}_{n - 2} ⋅ {l}_{n - 2}\right| = {b}_{n - 3}\end{matrix}\right) \qquad \text{(15)}$$
Preferably, the method further comprises:
Step 4: analyzing the maximum pressure that each guide rail surface can bear according to the maximum moving speed of the sliding plate assembly, calculating the maximum allowable pressure of each guide rail surface, wherein in order to avoid the problem of machining accuracy reduction caused by excessive unloading and moving part floating, the vertical pressure on each horizontal guide rail surface after unloading is p≥0.025 MPa, and the vertical unloading ratio of a gantry-type machining center beam is less than or equal to 0.7, and calculating the minimum pressure of each guide rail surface; solving the allowable range of an unloading force based on the allowable range of the pressure on each guide rail surface;
Step 5: integrating the results of all distribution regions of the rotation center to analyze the relationship between the load-bearing condition of each guide rail surface and the variation of a vertical unloading force F₁ and a horizontal unloading force F₂;
Step 6: taking the maximum value in the allowable range of the vertical unloading force, so as to minimize the load borne by the lower guide rail surface in the vertical direction and improve the geometric accuracy;
Step 7: solving the horizontal unloading force when the pressure on the upper guide rail surface is the same as that on the lower guide rail surfaces, so as to make the lives of the guide rail surfaces be the same and make the overall life of the guide rail be the longest;
Step 8: calculating the load-bearing condition of each guide rail surface, and verifying the load-bearing condition by the limit load-bearing range of each guide rail surface;
Step 9: calculating the magnitude of the component force provided by each booster mechanism according to the magnitude of a selected unloading force and the number of booster mechanisms arranged at the same position, and then completing the part design of the booster mechanisms.

Preferably, in the step 2, S is the stressed area of each guide rail surface, and the stiffness k of the contact surface is calculated according to the deformation-load characteristic curve of a TSF soft belt with a specific thickness:

$$\text{k} = \frac{\text{Δ} σ}{\text{Δ} δ} \qquad \text{(14)}$$

Where, Δσ is the pressure borne by the TSF soft belt with a specific thickness, and Δδ is the compressive deformation of the TSF soft belt at this pressure;

In the step 3, a system of geometrical relationship equations when the rotation center is in each region is established by dividing the distribution regions of the rotation center:

$$\left\{\begin{matrix}\left|sin {β}_{i} ⋅ {l}_{i} + {λ}_{i} ⋅ sin {β}_{i + 1} ⋅ {l}_{i + 1}\right| = {a}_{i} \\ \left|cos {β}_{i} ⋅ {l}_{i} + {ψ}_{i} ⋅ cos {β}_{i + 1} ⋅ {l}_{i + 1}\right| = {b}_{i}\end{matrix}\right) {λ}_{i} = \left\{- 1 , 1\right\} , {ψ}_{i} = \left\{- 1 , 1\right\} \qquad \text{(17)}$$

Based on the above equations, the mathematical model when the rotation center is located in different regions is established;

$$\left\{\begin{matrix}\sum {F}_{X} = 0 \\ \sum {F}_{Y} = 0 \\ \sum \text{M} = 0 \\ \left|sin {β}_{1} ⋅ {l}_{1} + {λ}_{1} ⋅ sin {β}_{2} ⋅ {l}_{2}\right| = {a}_{1} \\ \left|cos {β}_{1} ⋅ {l}_{1} + {ψ}_{1} ⋅ cos {β}_{2} ⋅ {l}_{2}\right| = {b}_{1} \\ ⋮ \\ \left|sin {β}_{n - 1} ⋅ {l}_{n - 1} + {λ}_{n} ⋅ sin {β}_{n} ⋅ {l}_{n}\right| = {a}_{n} \\ \left|cos {β}_{n - 1} ⋅ {l}_{n - 1} + {ψ}_{n} ⋅ cos {β}_{n} ⋅ {l}_{n}\right| = {b}_{n}\end{matrix}\right) \qquad \text{(18)}$$

In the step 4, the limit load-bearing value of each plastic laminated surface is calculated according to the maximum moving speed vₘₐₓ of a sliding plate on the y axis and the limiting pv value of the soft belt:

$${{F}^{′}}_{m a x} = p ⋅ S = \frac{p v ⋅ S}{{v}_{m a x}} \qquad \text{(16)}$$

When a pretightening guide rail surface is located on the opposite side of a main load-bearing guide rail surface, as the actual value of resultant force F on the main load-bearing guide rail surface is the sum of a theoretical value and a pretightening force on the corresponding pretightening guide rail surface, and according to the design principle that the pretightening force shall not exceed 0.2 times the limit pressure, the pressure on the main load-bearing guide rail surface is obtained:

$${F}_{m a x} = \left(1 - 0.2\right) {{F}^{′}}_{m a x} \qquad \text{(17)}$$

In summary, the allowable range Φᵢ of the pressure Fᵢ on each guide rail surface is obtained.

Preferably, in the step 5, a unidirectional unloading force has a great influence on the load-bearing condition of the guide rail in the same direction, but has a small influence on the pressure of the guide rail surface in a different direction; when unloading forces are only in the vertical direction and the horizontal direction, the selection of the unloading forces in the two directions is analyzed independently; in the step 5, if the included angle between the direction of an unloading force and the horizontal surface of an unloading mechanism is less than 90°, the unloading force shall be decomposed in the vertical direction and the horizontal direction to obtain the functional relationship between the components in the two directions and the unloading force:

$$\left\{\begin{matrix}{F}_{s x} = cos {β}_{s} ⋅ {F}_{s} \\ {F}_{s y} = sin {β}_{s} ⋅ {F}_{s}\end{matrix}\right) \qquad \text{(12)}$$

Fₛₓ and F_{sy} are taken as two unloading forces in different directions, and the mathematical model is established according to the same method to further complete the design of unloading forces.

The method of the present invention has the following effects: first, the innovation in the mathematical model: in the present invention, the guide rail surfaces are divided into the main load-bearing guide rail surfaces and the pretightening guide rail surfaces, stress analysis is conducted to the main load-bearing guide rail surfaces independently, and overturning angle is introduced, and a system of deformation compatibility equations is established based on the rigidity and deformation of a plastic guide rail, thus to establish the mathematical model.

Second, the innovation in the calculation satisfying the maximum moving speed of the sliding plate assembly: in the present invention, the interacting relationship between the moving speed and the pressure of the guide rail surfaces is considered, and the maximum moving speed of the plastic guide rail is taken as a constraint condition to propose an unloading force solving method satisfying any target moving speed.

Next, the innovation in the optimal solution selection of the unloading force: in the present invention, an optimal solution of the unloading force satisfying the reasonable load distribution on the main guide rail surfaces and ensuring the straightness of the lower guide rail is obtained according to the load distribution principle of small load distribution on a lower guide rail in the vertical direction and even load distribution on the upper and lower main guide rail surfaces.

Finally, the innovation in the quantification of the load-bearing condition of each guide rail surface: in the present invention, the pretightening force is selected to a certain scale, and the solution of the force and pressure on all guide rail surfaces is realized by substituting the optimal solution of the unloading force. The ultimate purpose of the present invention is to realize the rapid movement of the sliding plate assembly at a specific speed, and make the load distribution on each guide rail surface reasonable, so as to meet the design requirements of a machining center, ensure the straightness of the beam guide rail and improve the machining accuracy and the life of the guide rail.

### DESCRIPTION OF DRAWINGS

FIG. 1 is a schematic diagram of a mounting structure of an unloading device for a gantry-type machining center beam guide rail of the present invention;

FIG. 2 is a schematic diagram of an unloading device for a gantry-type machining center beam guide rail of the present invention assembled with a beam guide rail;

FIG. 3 is a schematic diagram of a first booster mechanism of an unloading device for a gantry-type machining center beam guide rail of the present invention;

FIG. 4 is a schematic diagram of a second booster mechanism of an unloading device for a gantry-type machining center beam guide rail of the present invention;

FIG. 5 is an installation schematic diagram of a second booster mechanism of an unloading device for a gantry-type machining center beam guide rail of the present invention;

FIG. 6 is a schematic diagram of each guide rail surface of a beam guide rail of an unloading device for a gantry-type machining center beam guide rail of the present invention;

FIG. 7 is a stress analysis diagram of a sliding plate assembly of an unloading device for a gantry-type machining center beam guide rail of the present invention;

FIG. 8 is an overturning state analysis diagram of a sliding plate assembly of an unloading device for a gantry-type machining center beam guide rail of the present invention;

FIG. 9 is an upper and lower main guide rail pressure difference analysis diagram in an embodiment of an unloading device for a gantry-type machining center beam guide rail of the present invention.

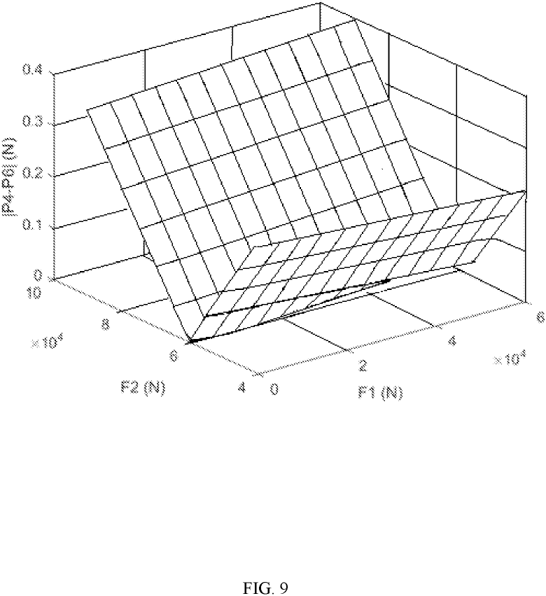

1 sliding plate assembly, 2 beam guide rail, 21 upper guide rail surface, 22 lower guide rail surface, 23 unloading guide rail horizontal surface, 24 unloading guide rail vertical surface, 25 pretightening guide rail surface, 3 first booster mechanism, 31 worm, 32 worm gear gland, 33 worm gear shaft, 34 worm gear, 35 retaining sleeve assembly, 351 worm gear retaining sleeve, 352 disk spring, 36 first mounting bracket, 37 first sliding block, 4 second booster mechanism, 41 unloading bolt, 42 second mounting bracket, 43 second sliding block, 5 shaft lever, 6 mounting groove, 7 baffle plate, 8 round nut, 9 inner corner blind hole.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

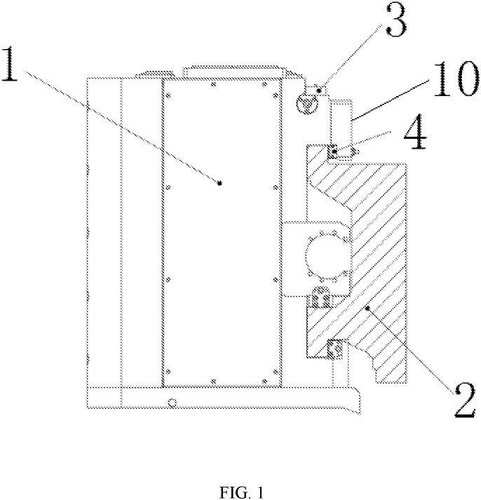

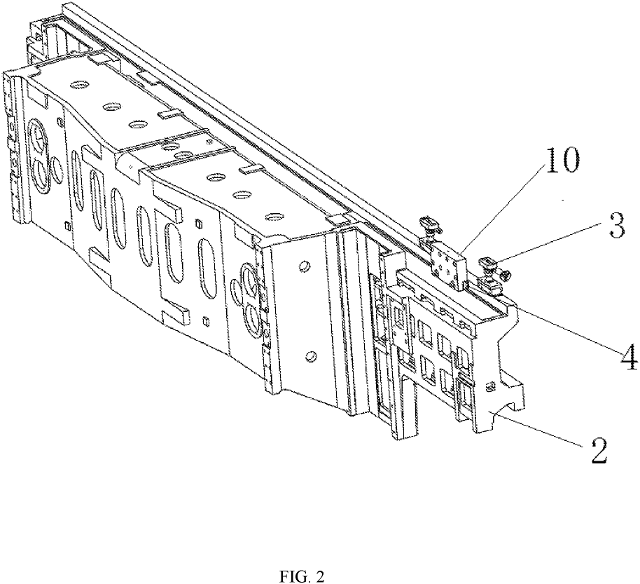

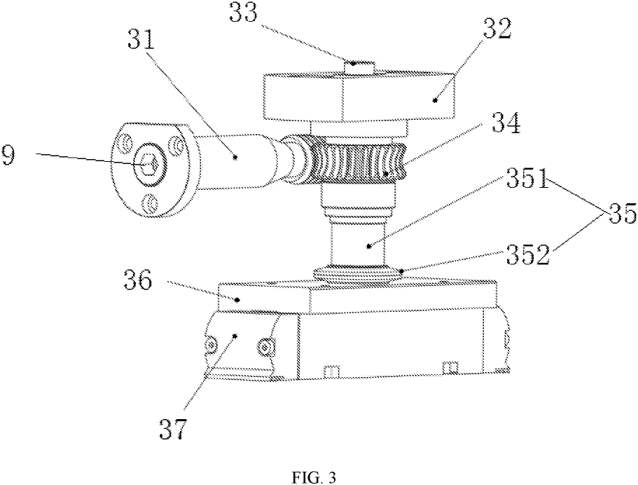

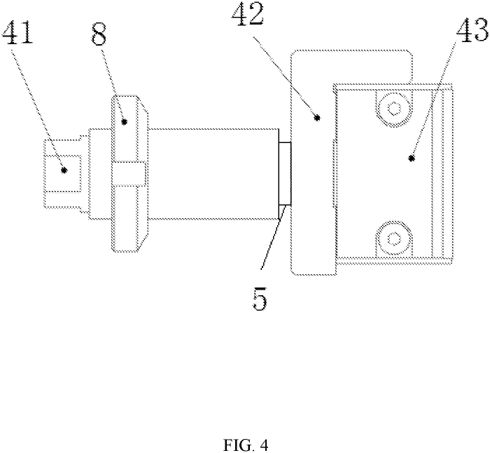

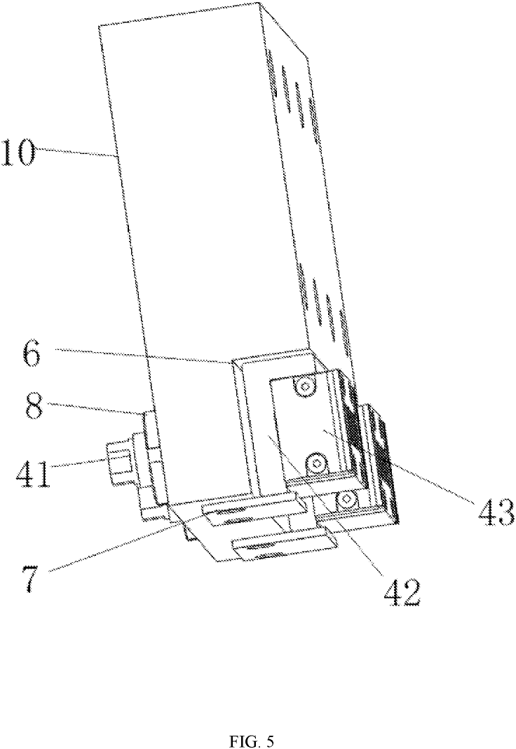

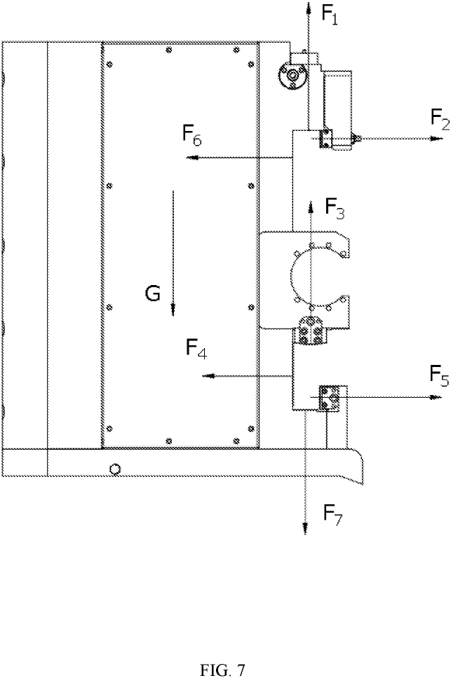

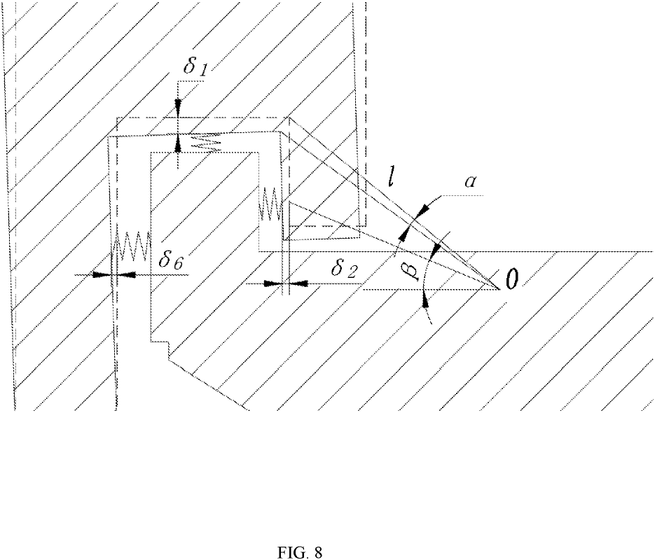

Referring to FIGS. 1-8 of the present invention, an unloading device for a gantry-type machining center beam guide rail according to an embodiment of the present invention, which is used to be installed on a sliding plate assembly 1, wherein the sliding plate assembly 1 is slidably connected with a beam guide rail 2 of a gantry-type machining center, and the beam guide rail 2 has an upper guide rail surface 21, lower guide rail surfaces 22, an unloading guide rail horizontal surface 23, an unloading guide rail vertical surface 24 and pretightening guide rail surfaces 25; the unloading device comprises:

A first booster mechanism 3, wherein the first booster mechanism 3 comprises a worm 31, a worm gear gland 32, a worm gear shaft 33, a worm gear 34, a retaining sleeve assembly 35, a first mounting bracket 36 and a first sliding block 37, the worm 31 is horizontally and rotationally connected with the sliding plate assembly 1, the worm gear gland 32 is fixed on the sliding plate assembly 1, a screw hole is formed in the worm gear gland 32, the top end of the worm gear shaft 33 is connected in the screw hole through threads, the worm gear 34 is fixed on the worm gear shaft 33 and is engaged with helical teeth of the worm, a shaft hole is formed in the first mounting bracket 36, the bottom end of the worm gear shaft 33 is slidably connected in the shaft hole, the retaining sleeve assembly 35 is sheathed on the worm gear shaft 33, the retaining sleeve assembly 35 is butted with the first mounting bracket 36, the first sliding block 37 is installed on the first mounting bracket 36, and the first sliding block 37 is slidably connected with the unloading guide rail horizontal surface 23;

The first booster mechanism uses the worm couple and a disk spring to realize the adjustment of a vertical unloading force; when the worm rotates and drives the worm gear to rotate, an axial displacement can be generated by the worm gear along the worm gear shaft to compress the disk spring, make an unloading force generated by the disk spring act on a rolling element bracket, and make the first sliding block tightly pressed against the unloading guide rail horizontal surface;

A second booster mechanism 4, wherein the second booster mechanism 4 comprises an unloading bolt 41, a second mounting bracket 42 and a second sliding block 43, an unloading press plate 10 is fixed on one side of the sliding plate assembly 1, the unloading bolt 41 is horizontally connected with the unloading press plate 10 through threads, a through hole is formed in the second mounting bracket 42, a shaft lever 5 is coaxially fixed on one end of the unloading bolt 41, the shaft lever 5 is fitted in the through hole, one end of the unloading bolt is butted with the second mounting bracket; the second sliding block 43 is connected with the second mounting bracket 42, and the second sliding block 43 is slidably connected with the unloading guide rail vertical surface 24. The unloading bolt is rotated to generate an axial displacement, thus to push the second mounting bracket to approach the beam guide rail in the horizontal direction, and make the second sliding block pressed against the beam guide rail to complete the unloading adjustment of the sliding plate assembly.

In some other embodiments, the retaining sleeve assembly 35 comprises a worm gear retaining sleeve 351 and a disk spring 352, the worm gear shaft 33 is a stepped shaft, the worm gear retaining sleeve 351 and the disk spring 352 are respectively sheathed on the peripheral side of the worm gear shaft 33, the top end of the worm gear retaining sleeve 351 is butted with the shoulder of the worm gear shaft, the bottom end of the worm gear retaining sleeve 351 is butted with the top end of the disk spring, and the bottom end of the disk spring 352 is butted with the top end surface of the first mounting bracket 36. The worm gear retaining sleeve is pushed by the axial displacement of the worm gear shaft to move, thus to push the disk spring and make the unloading force generated by the disk spring act on the first mounting bracket, and therefore, the disk spring can make the movement of the mechanism more stable, the stroke shorter and the load larger.

In some other specific embodiments, a mounting groove 6 is formed in the bottom of one side of the unloading press plate 10, a threaded hole is horizontally formed in the unloading press plate 10 corresponding to the bottom of the mounting groove 6, the unloading bolt 41 is connected with a round nut 8, and the round nut 8 is butted with the wall of the other side of the unloading press plate 10. The round nut can lock the unloading bolt to complete locking after unloading adjustment.

In some other embodiments, the bottom end of the unloading press plate 10 is horizontally and fixedly connected with a baffle plate 7, the second mounting bracket 42 is located in the mounting groove 6, and the bottom end of the second mounting bracket 42 is slidably connected with the baffle plate 7. The baffle plate can ensure the stable operation of the second mounting bracket.

Specifically, the first sliding block 37 and the second sliding block 43 are rolling sliding blocks for machine tools. A plurality of rollers are installed on the bottom of each sliding block.

In some other embodiments, the outer sidewall of one end of the worm 31 is fixedly connected with a fixed seat, a plurality of screw holes are formed in the fixed seat, the fixed seat is fixedly connected with the sliding plate assembly 1 through screws to limit the rotation of the worm 31, and an inner corner blind hole 9 used for driving the worm to rotate is formed in one end of the worm 31. The fixed seat is used for positioning the worm after adjustment, and the inner corner blind hole is convenient for using a tool to rotate the worm.

An unloading method for a gantry-type machining center beam guide rail:

A mathematical model used for solving unknown parameters is established by introducing a rotation angle of the sliding plate assembly, a rotation center and the stiffness of each guide rail surface. A solution of the unloading force is obtained according to the load distribution principle of small load distribution on a lower guide rail in the vertical direction and even load distribution on the upper and lower guide rail surfaces and based on the analysis of the maximum moving speed of the sliding plate assembly. The ultimate purpose of the present invention is to realize the rapid movement of the sliding plate assembly at a specific speed, and make the load distribution on each guide rail surface reasonable, so as to meet the design requirements of a machining center and improve the machining accuracy and the life of the guide rail.

A method for determining the rotation center:

1. The points which coincide before and after rotation are regarded as the corresponding points of two diagrams.

2. Two groups of corresponding points are found, the corresponding points in each group are connected respectively, and perpendicular bisectors of the connecting lines are drawn. The intersection point is the rotation center.

### Establishing Mathematical Model First

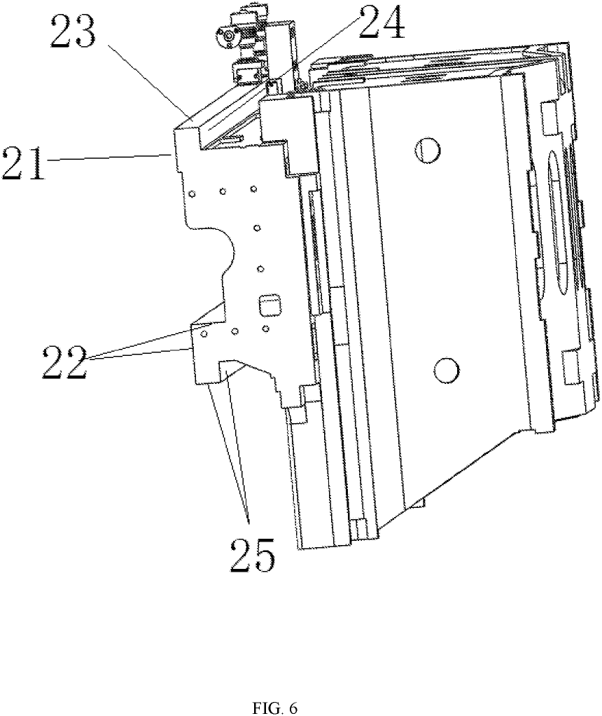

Step 1: regarding a guide rail surface which bears a load only playing a pretightening role and has no resistance to an overturning trend of the sliding plate assembly as the pretightening guide rail surfaces according to the actual engineering, regarding the other guide rail surfaces (excluding the unloading guide rail horizontal surface and the unloading guide rail vertical surface) as main load-bearing guide rail surfaces, dividing the guide rail surfaces on the beam guide rail (2) shown in FIG. 6 into the upper guide rail surface (21), the lower guide rail surfaces (22), the unloading guide rail horizontal surface (23), the unloading guide rail vertical surface (24) and the pretightening guide rail surfaces (25), and establishing a system of supporting force balance equations for each main load-bearing guide rail surface through stress analysis:

$$\left\{\begin{matrix}\sum {F}_{X} = 0 \\ \sum {F}_{Y} = 0 \\ \sum \text{M} = 0\end{matrix}\right)$$

The upper guide rail surface (21) is an upper vertical surface near one side of the sliding plate assembly, the lower guide rail surfaces (22) include a lower vertical surface and a lower horizontal surface, the unloading guide rail horizontal surface (23) is an upper horizontal surface, the unloading guide rail vertical surface (24) is a vertical surface arranged in parallel with the upper vertical surface, the pretightening guide rail surfaces (25) are arranged in parallel with the lower horizontal surface and the lower vertical surface, and the lower vertical surface is arranged on one side of the sliding plate assembly;

Letting a rotation angle formed by the overturning effect of the sliding plate assembly be α and a vertical deformation of a plastic laminated surface be δ; assuming that the distance between the rotation center and the application point of a resultant force F on each guide rail surface is l, an included angle between an application point connecting line and the horizontal direction is β, and the rotation angle is towards the overturning direction of the sliding plate assembly; and obtaining deformation compatibility equations:

$$\text{δ} = cos β α l$$

$$\text{F} = cos β α l k S$$

Where, S is the stressed area of each guide rail surface, and the stiffness k of the contact surface is calculated according to the deformation-load characteristic curve of a TSF soft belt with a specific thickness:

$$\text{k} = \frac{\text{Δ} σ}{\text{Δ} δ}$$

Where, Δσ is the pressure borne by the TSF soft belt with a specific thickness, and Δδ is the compressive deformation of the TSF soft belt at this pressure.

Establishing a system of geometrical relationship equations when the rotation center is in each region by dividing the distribution regions of the rotation center:

$$\left\{\begin{matrix}sin {β}_{k} ⋅ {l}_{k} + sin {β}_{j} ⋅ {l}_{j} = a \\ cos {β}_{k} ⋅ {l}_{k} - cos {β}_{j} ⋅ {l}_{j} = b\end{matrix}\right)$$

Establishing the mathematical model when the rotation center is located in different regions according to the above equations.

### Analyzing Maximum Moving Speed of Sliding Plate

Step 2: calculating the limit load-bearing value of each plastic laminated surface according to the maximum moving speed vₘₐₓ of the sliding plate assembly on the y axis and the limiting pv value of the soft belt:

$${{F}^{′}}_{m a x} = p ⋅ S = \frac{p v ⋅ S}{{v}_{m a x}}$$

when a pretightening guide rail surface is located on the opposite side of a main load-bearing guide rail surface, as the actual value of resultant force F on the main load-bearing guide rail surface is the sum of a theoretical value and a pretightening force on the corresponding pretightening guide rail surface, and according to the design principle that the pretightening force shall not exceed 0.2 times the limit pressure, the pressure on the main load-bearing guide rail surface is obtained:

$${F}_{m a x} = \left(1 - 0.2\right) {{F}^{′}}_{m a x}$$

According to Modern Practical Machine Design Manual, in order to avoid the problem of machining accuracy reduction caused by excessive unloading and moving part floating, the vertical pressure on each horizontal guide rail surface after unloading is p≥0.025 MPa, and the vertical unloading ratio of a gantry-type machining center beam is less than or equal to 0.7; thereby, the minimum pressure of each guide rail surface is calculated.

In summary, the allowable range Φᵢ of the pressure Fᵢ on each guide rail surface can be obtained.

### Solving Optimal Value of Unloading Force

Step 3: solving the mathematical model based on boundary conditions, considering the physical meaning of each parameter, and obtaining the boundary conditions:

$$\text{α} , {l}_{i} , {β}_{i} > 0$$

Integrating the results of all regions meeting the boundary conditions to analyze the relationship between the load-bearing condition of each guide rail surface and the variation of the unloading forces F₁ and F₂; it can be known that a specific unloading force has a great influence on the load-bearing condition of the guide rail in the same direction, but has a small influence on the pressure of the guide rail surface in a different direction, so the unloading forces in two directions are solved independently.

For the selection of the vertical unloading force F₁, calculating according to the balance equation ΣF_{Y}-0:

$${F}_{1} = G - {F}_{3}$$

Calculating the allowable range Φ₁ of the vertical unloading force F₁ according to the allowable range Φ₃ of F₃, and taking the maximum value F₁′ in the allowable range as the selected value of the vertical unloading force; the reason is that the machining accuracy of a gantry-type machining center is affected more by the straightness of the lower guide rail, therefore, the force F₃ borne by the lower guide rail in the vertical direction shall be as small as possible, so as to improve the geometric accuracy of the guide rail.

For the selection of the horizontal unloading force F₂, analyzing the variation relationship between the pressure difference |P3-P6| of the upper and lower main guide rail surfaces and the horizontal unloading force F₂ by solving the mathematical model, and setting the vertical unloading force F₁ to a fixed value. Therefore, when the pressure difference |P3-P6| of the upper and lower guide rail surfaces approaches the minimum value, the horizontal unloading force F₂′ obtained by solving is the selected value. In this case, the pressures borne by the plastic soft belts of the upper and lower main guide rail surfaces are the same, so as to ensure that the lives of the two main guide rail surfaces are the same and the overall life of the guide rail is the longest.

### Calculating Load-Bearing Condition of Each Guide Rail Surface

Step 4: substituting the selected values of two unloading forces F₁ and F₂ into the mathematical model to calculate the load on each of the other guide rail surfaces, and comparing the calculation results with the allowable range Φᵢ of the pressure on each guide rail surface. When a designed unloading force meets the limit load requirements for the maximum moving speed and the minimum pressure of the guide rail surface, judging whether the selection of the unloading force meets the design requirements.

Taking the actual calculation of a CNC gantry-type five-sided machining center as an example to illustrate the selection of the unloading force and the method for calculating the load-bearing condition of the main load-bearing guide rail surfaces. According to the known conditions, the gravity of the sliding plate assembly is G=63700N, the limitingpv value of the TSF plastic soft belt is 30 MPa·m·min⁻¹, and the maximum moving speed of the sliding plate is vₘₐₓ=25 m·min⁻¹, so the stressed area of each guide rail surface is:

$${S}_{3} = 49000 m {m}^{2}$$

$${S}_{4} = 130000 m {m}^{2}$$

$${S}_{6} = 95000 m {m}^{2}$$

Calculating the maximum allowable value of the acting force on each main load-bearing guide rail surface:

$${F}_{1 m a x} = 0.7 G = 44590 N$$

$${F}_{3 m a x} = \left(1 - 0.2\right) {{F}^{′}}_{3 m a x} = \frac{0.8 p v ⋅ {S}_{3}}{{v}_{m a x}} = 47040 N$$

$${F}_{4 m a x} = \left(1 - 0.2\right) {{F}^{′}}_{4 m a x} = \frac{0.8 p v ⋅ {S}_{4}}{{v}_{m a x}} = 124800 N$$

$${F}_{6 m a x} = \left(1 - 0.2\right) {{F}^{′}}_{6 m a x} = \frac{0.8 p v ⋅ {S}_{6}}{{v}_{m a x}} = 91200 N$$

Calculating the minimum allowable value of F₃ according to the condition that the vertical pressure on each guide rail surface is p≥0.025 MPa:

$${F}_{3 m i n} = {p}_{m i n} ⋅ {S}_{3} = 1255 N$$

Thus obtaining the allowable range Φᵢ of the pressure Fᵢ on each guide rail surface:

$${ϕ}_{3} = \left[1225 , 47040 N\right]$$

$${ϕ}_{4} = \left[0 , 124800 N\right]$$

$${ϕ}_{6} = \left[0 , 91200 N\right]$$

For the selection of the vertical unloading force F₁, calculating according to the balance equation ΣF_{Y}-0:

$$16660$$

Thus obtaining the allowable range Φ₁ of the vertical unloading force F₁:

$${ϕ}_{1} = \left[16660 , 44590 N\right]$$

According to the principle of small load on the lower guide rail in the vertical direction:

$${F}_{1} = 44590 N$$

Calculating according to the balance equation ∑F_{Y}=0:

$${F}_{3} = G - {F}_{1} = 62475$$

Substituting the calculated F₁ and F₃ into the system of equations, taking a step size of 20000 N in a range of [40000, 100000 N] for the unloading force F₂ to obtain the value of each parameter by the mathematical model, and analyzing the variation relationship between the pressure difference |P4-P6| of the upper and lower main guide rail surfaces and the unloading force F₂ according to the principle of even load distribution on the upper and lower main guide rail surfaces. As shown in the figure, when F₂ approaches 60000 N, |P4-P6| approaches the minimum value. Therefore, by continuously reducing the solution range and step size of F₂, the horizontal unloading force when |P4-P6| reaches the minimum value is finally selected when the solution step size is 1 N:

$${F}_{2} = 58625 N$$

Substituting the obtained F₁, F₂ and F₃ into the system of equations to obtain the stress of the other guide rail surfaces:

$${F}_{4} = 33946.1 N$$

$${F}_{6} = 24678.9 N$$

### Designing and Checking Booster Mechanisms

Step 5: the first booster mechanism uses the worm couple and the disk spring to realize the adjustment of the vertical unloading force, wherein the worm gear shaft hole of the worm gear gland has internal threads; when the worm rotates and drives the worm gear to rotate, an axial displacement can be generated by the worm gear along the worm gear shaft to compress the disk spring, make an unloading force generated by the disk spring act on the first mounting bracket, and make the first sliding block tightly pressed against the unloading guide rail horizontal surface.

The second booster mechanism is installed on the unloading press plate, the unloading bolt is connected with the press plate through threads, the unloading bolt is rotated to generate an axial displacement, and the second sliding block is pressed tightly against the unloading guide rail vertical surface by the second mounting bracket to generate an unloading force.

### Designing and Checking Worm Couple

For the design of the worm couple, primarily selecting the transmission ratio i of the worm couple, and selecting the number of threads of worm z₁ and the number of worm gear teeth z₂.

Matching the internal threads of the worm gear shaft hole with the worm gear shaft. Looking up the nominal diameter D, the pitch P, the pitch diameter D′ and the flank angle α of the threads according to the spatial structure dimension of the unloading device and based on the diameter and pitch series as well as the basic dimensions for general purpose metric screw threads (GB/T196-2003), and calculating the lead angle:

$$λ = arctan \frac{P}{π \text{} {d}_{2}}$$

Determining the safety factor S_{H} for contact strength and the load factor K of the selected worm gear material, and calculating the allowable contact stress according to the contact fatigue limit stress σ_{H1im}:

$${σ}_{H P} = \frac{{σ}_{H l i m}}{{S}_{H}}$$

After determining an axial clamping force F_{q} of the booster mechanism and an equivalent friction angle φ₀, taking a friction factor f₁ of a bearing surface, and primarily selecting the inner diameter D₁ and outer diameter D₂ of the worm gear, the moment arm of the friction moment of the bearing surface can be calculated:

$$τ = \frac{{D}_{2}^{3} - {D}_{1}^{3}}{3 \left({D}_{2}^{2} - {D}_{1}^{2}\right)}$$

A torque T₂ of the worm gear shaft can be calculated according to a calculation formula of the clamping force of the helical booster mechanism.

$${F}_{q} = \frac{2 {T}_{2}}{{D}^{′} tan \left(λ + {φ}_{0}\right) + 2 {f}_{1} τ}$$

As the worm couple in the booster mechanism is not constantly kept in transmission movement, the worm couple is designed according to a U coefficient method. A check and calculation formula of the U coefficient method is known:

$$U = {K}_{A} {F}_{t 2} m / {b}_{2} ⩽ {U}_{P} = {U}_{lim} / {S}_{F min}$$

### Calculating the Circumferential Force of the Worm Gear: Ft₂=T₂/d₂

Deriving a worm gear parameter design and calculation formula, selecting a worm gear modulus m, a worm gear reference diameter d₂ and a worm reference diameter d₁ according to the basic parameters of cylindrical worm gears (GB10085-2018), calculating the number of worm gear teeth z₂=d₂/m, and obtaining a worm span L according to a value range L≥(12+0.1z₂)ₘ of the worm span and the spatial structure dimension.

$${d}_{2} {b}_{2} m ⩾ {K}_{A} {T}_{2} {S}_{F l i m} / {U}_{lim}$$

The center distance of the worm couple can be calculated according to the designed tooth width B₂.

$$α = \frac{{d}_{1} + {d}_{2}}{2}$$

Then checking the external threads of the worm gear shaft and the worm couple of the first booster mechanism:

Determining the maximum axial load of the worm gear shaft according to the lead angle and the torque of the worm gear:

$$F = \frac{T ⋅ tan λ}{{D}_{2}}$$

Determining the safety factor S according to a controlled pretightening force, and calculating the allowable stress [σ]=σₛ/S of the threads,

Calculating the minimum diameter of the threads according to the strength condition.

$${d}_{m i n} ⩾ \sqrt{\frac{4 \times 1.3 {F}_{z 1}}{π \left[σ\right]}}$$

Based on the diameter and pitch series as well as the basic dimensions for general purpose metric screw threads (GB/T196-2003), when the selected minimum diameter of the threads is d₁<d_{1 min}, the external threads of the worm gear shaft meet the strength requirement.

### Selecting Disk Spring

For the selection of the disk spring in the first booster mechanism, according to the characteristic curve of the disk spring, and in order to meet the requirement that the characteristic curve approaches a straight line, letting:

$$\frac{{h}_{0}}{t} \leq 0.5$$

When the diameter ratio of the disk spring is C=D/d≈1.7, the deformation of unit volume of material of the disk spring is the maximum; as a too large C value will lead to a too large diameter of the disk spring, letting C=1.7-2.

With the increase of the ratio

$$\frac{s}{{h}_{0}}$$

between the deformation of the disk spring and the maximum deformation stroke, the actual lever arm is shortened, and the difference between the actual bearing capacity of the spring and the calculated value is increased. When

$$\frac{s}{{h}_{0}} > 0.75 ,$$

the difference is very obvious. Specifying

$$\frac{{s}_{m a x}}{{h}_{0}} = 0.75$$

according to GB/T1872. When

$$\frac{s}{{h}_{0}} <$$

0.15-0.20, a crack may appear at point I. Therefore, the selected spring shall meet the load-bearing condition when

$$0.20 < \frac{s}{{h}_{0}} < 0.60.$$

Given that the number of booster mechanisms in the same direction is n, the load on each booster mechanism is

$${F}_{q} = \frac{{F}_{1}}{n} .$$

Completing the selection of disk springs in the booster mechanisms in the horizontal direction and the vertical direction according to the product parameters provided by various manufacturers and based on the above selection principles.

Analyzing the deformation s when the load on a single disk spring is F_{q} based on the load deformation curve of the single disk spring, calculating the number of rotations of the worm for adjusting the unloading force from 0 to a target value in the condition of using a single disk spring by deriving the lead angle and the transmission ratio, and completing the design of the combination form of the disk spring by considering the sensitivity of loading force adjustment and the ideal stroke of spring compression.

The check of the solution and design schemes of a gantry-type machining center beam guide rail can be realized through the above calculation and check.

### Designing and Checking Bolt of Second Booster Mechanism

For the design of the bolt in the second booster mechanism, because the bolt is usually in a working environment under variable load, vibration and impact load, and is required to have an adjustment function as a fine tuning mechanism, a stud with general purpose coarse threads can be selected for connection.

Calculating the maximum working load

$$F = \frac{{F}^{′}}{z}$$

for each bolt according to the number of bolts z, determining the safety factor S according to the controlled pretightening force, calculating the allowable stress

$$\left[σ\right] = \frac{{σ}_{\text{s}}}{S}$$

of the threads, and calculating the minimum diameter of the bolt d₁ₘᵢₙ by a formula

$${d}_{min} \geq \sqrt{\frac{4 \times 1.3 {F}_{z 1}}{π \left[σ\right]}} .$$

Based on the diameter and pitch series as well as the basic dimensions for general purpose metric screw threads (GB/T196-2003), when the selected minimum diameter of the threads is d₁<d₁ₘᵢₙ, the bolt of the second booster mechanism meets the strength requirement.

### Checking Bolt Spacing

When a plurality of unloading bolts are used on the same press plate, the bolt spacing need to be checked. According to the engineering experience, when the connection is used for a general purpose, the maximum allowable bolt spacing for bolt connection is t₀≤10d. Stud spacing shall also meet the requirements for a wrench space. Determining the spacing parameter A according to the dimension of the wrench space (JB/ZQ4005-1997). When the actual spacing between any two studs on the same press plate is t₀′>A, judging whether the bolt spacing meets the design requirements.

For a device and a use method disclosed by the embodiments, because the device and the use method correspond to a method disclosed by the embodiments, the device and the use method are simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. An unloading device for a gantry-type machining center beam guide rail, which is used to be installed on a sliding plate assembly (1), wherein the sliding plate assembly (1) is slidably connected with a beam guide rail (2) of a gantry-type machining center, and the beam guide rail (2) has an upper guide rail surface (21), lower guide rail surfaces (22), an unloading guide rail horizontal surface (23), an unloading guide rail vertical surface (24) and pretightening guide rail surfaces (25); the unloading device comprises: a first booster mechanism (3), wherein the first booster mechanism (3) comprises a worm (31), a worm gear gland (32), a worm gear shaft (33), a worm gear (34), a retaining sleeve assembly (35), a first mounting bracket (36) and a first sliding block (37), the worm (31) is horizontally and rotationally connected with the sliding plate assembly (1), the worm gear gland (32) is fixed on the sliding plate assembly (1), a screw hole is formed in the worm gear gland (32), the top end of the worm gear shaft (33) is connected in the screw hole through threads, the worm gear (34) is fixed on the worm gear shaft (33) and is engaged with helical teeth of the worm, a shaft hole is formed in the first mounting bracket (36), the bottom end of the worm gear shaft (33) is slidably connected in the shaft hole, the retaining sleeve assembly (35) is sheathed on the edge of the bottom end of the worm gear shaft (33), the bottom end of the retaining sleeve assembly (35) is butted with the first mounting bracket (36), the first sliding block (37) is installed on the bottom end of the first mounting bracket (36), and the bottom end of the first sliding block (37) is slidably connected with the unloading guide rail horizontal surface (23);
a second booster mechanism (4), wherein the second booster mechanism (4) comprises an unloading bolt (41), a second mounting bracket (42) and a second sliding block (43), an unloading press plate (10) is fixed on one side of the sliding plate assembly (1), the unloading bolt (41) is horizontally connected with the unloading press plate (10) through threads, a through hole is formed in the second mounting bracket (42), a shaft lever (5) is coaxially fixed on one end of the unloading bolt (41), the shaft lever (5) is rotationally connected in the through hole, one end of the unloading bolt (41) is butted with the second mounting bracket (42), the second sliding block (43) is fixedly connected with one side of the second mounting bracket (42) away from the unloading bolt (41), and the second sliding block (43) is slidably connected with the unloading guide rail vertical surface (24).

2. The unloading device for a gantry-type machining center beam guide rail according to claim 1, wherein the retaining sleeve assembly (35) comprises a worm gear retaining sleeve (351) and a disk spring (352), the worm gear shaft (33) is a stepped shaft, the worm gear retaining sleeve (351) and the disk spring (352) are respectively sheathed on the peripheral side of the worm gear shaft (33), the top end of the worm gear retaining sleeve (351) is butted with the shoulder of the worm gear shaft, the bottom end of the worm gear retaining sleeve (351) is butted with the top end of the disk spring, and the bottom end of the disk spring (352) is butted with the top end surface of the first mounting bracket (36).

3. The unloading device for a gantry-type machining center beam guide rail according to claim 2, wherein a mounting groove (6) is formed in the bottom of one side of the unloading press plate (10), a threaded hole is horizontally formed in the unloading press plate (10) corresponding to the bottom of the mounting groove (6), the unloading bolt (41) is connected with a round nut (8), and the round nut (8) is butted with the wall of the other side of the unloading press plate (10).

4. The unloading device for a gantry-type machining center beam guide rail according to claim 3, wherein the bottom end of the unloading press plate (10) is horizontally and fixedly connected with a baffle plate (7), the second mounting bracket (42) is slidably connected in the mounting groove (6), and the bottom end of the second mounting bracket (42) is slidably connected with the baffle plate (7).

5. The unloading device for a gantry-type machining center beam guide rail according to claim 4, wherein the first sliding block (37) and the second sliding block (43) are rolling sliding blocks for machine tools.

6. The unloading device for a gantry-type machining center beam guide rail according to claim 1, wherein the outer sidewall of one end of the worm (31) is fixedly connected with a fixed seat, a plurality of screw holes are formed in the fixed seat, the fixed seat is fixedly connected with the sliding plate assembly (1) through screws to limit the rotation of the worm (31), and an inner corner blind hole (9) is formed in one end of the worm (31).

7. An unloading method for a gantry-type machining center beam guide rail, comprising the following steps:
step 1: dividing the guide rail surfaces on the beam guide rail (2) into the upper guide rail surface (21), the lower guide rail surfaces (22), the unloading guide rail horizontal surface (23), the unloading guide rail vertical surface (24) and the pretightening guide rail surfaces (25) according to the actual engineering, wherein a guide rail surface which bears a load only playing a pretightening role and has no resistance to an overturning trend of the sliding plate assembly is regarded as a pretightening guide rail surface, and the upper guide rail surface (21), the lower guide rail surfaces (22), the unloading guide rail horizontal surface (23) and the unloading guide rail vertical surface (24) are regarded as main load-bearing guide rail surfaces, and establishing a stress balance equation for each main load-bearing guide rail surface;
$$\left\{\begin{matrix}\sum {F}_{X} = 0 \\ \sum {F}_{Y} = 0 \\ \sum \text{M} = 0\end{matrix}\right) \qquad \text{(1)}$$
step 2: introducing a rotation angle α formed by the overturning effect of the sliding plate assembly (1), an included angle β between a connecting line from a rotation center to a corresponding unloading application point of the unloading guide rail vertical surface (24) and the horizontal direction, a vertical deformation δ of a plastic laminated surface, and coordinates of the rotation center, and obtaining deformation compatibility equations based on a stressed area S of each main load-bearing guide rail surface;
$$δ = cos β α l \qquad \text{(2)}$$
$$\text{F} = cos β α l k S \qquad \text{(3)}$$
assuming that the distance between the rotation center and the application point of a resultant force F on each main load-bearing guide rail surface is l, and the stiffness of a contact surface is k;
step 3: taking the horizontal and vertical coordinates of the application point of the resultant force on each guide rail surface as boundaries to divide the surface into a plurality of rectangular regions, overturning the sliding plate assembly (1) in a direction opposite to the position of the beam, judging the increasing and decreasing trend of the pressure of each guide rail surface compared with that when the sliding plate assembly (1) is not overturned, analyzing the pressure variation trend of each guide rail surface when the rotation center is located in each rectangular region, selecting each rectangular region with the variation trend conforming to the actual situation as a possible distribution region of the rotation center, establishing a geometric equation for each possible distribution region, and establishing a mathematical model based on the deformation compatibility equations and the balance equations.
$$\left\{\begin{matrix}\sum {F}_{X} = 0 \\ \sum {F}_{Y} = 0 \\ \sum \text{M} = 0 \\ \left|sin {β}_{1} ⋅ {l}_{1} + {λ}_{1} ⋅ sin {β}_{2} ⋅ {l}_{2}\right| = {a}_{1} \\ \left|cos {β}_{1} ⋅ {l}_{1} + {ψ}_{1} ⋅ cos {β}_{2} ⋅ {l}_{2}\right| = {b}_{1} \\ ⋮ \\ \left|sin {β}_{n - 3} ⋅ {l}_{n - 3} + {λ}_{n - 2} ⋅ sin {β}_{n - 2} ⋅ {l}_{n - 2}\right| = {a}_{n - 3} \\ \left|cos {β}_{n - 3} ⋅ {l}_{n - 3} + {ψ}_{n - 2} ⋅ cos {β}_{n - 2} ⋅ {l}_{n - 2}\right| = {b}_{n - 3}\end{matrix}\right) \qquad \text{(4)}$$
.

8. The unloading method for a gantry-type machining center beam guide rail according to claim 7, wherein the method further comprises the following steps:
step 4: analyzing the maximum pressure that each guide rail surface can bear according to the maximum moving speed of the sliding plate assembly, calculating the maximum allowable pressure of each guide rail surface, wherein in order to avoid the problem of machining accuracy reduction caused by excessive unloading and moving part floating, the vertical pressure on each horizontal guide rail surface after unloading isp≥0.025 MPa, and the vertical unloading ratio of a gantry-type machining center beam is less than or equal to 0.7, and calculating the minimum pressure of each guide rail surface; solving the allowable range of an unloading force based on the allowable range of the pressure on each guide rail surface;
step 5: integrating the results of all distribution regions of the rotation center to analyze the relationship between the load-bearing condition of each guide rail surface and the variation of a vertical unloading force F₁ and a horizontal unloading force F₂;
step 6: taking the maximum value in the allowable range of the vertical unloading force, so as to minimize the load borne by the lower guide rail surface in the vertical direction and improve the geometric accuracy;
step 7: solving the horizontal unloading force when the pressure on the upper guide rail surface is the same as that on the lower guide rail surfaces, so as to make the lives of the guide rail surfaces be the same and make the overall life of the guide rail be the longest;
step 8: calculating the load-bearing condition of each guide rail surface, and verifying the load-bearing condition by the limit load-bearing range of each guide rail surface;
step 9: calculating the magnitude of the component force provided by each booster mechanism according to the magnitude of a selected unloading force and the number of booster mechanisms arranged at the same position, and then completing the part design of the booster mechanisms.

9. The unloading method for a gantry-type machining center beam guide rail according to claim 8, wherein in the step 2, S is the stressed area of each guide rail surface, and the stiffness k of the contact surface is calculated according to the deformation-load characteristic curve of a TSF soft belt with a specific thickness:
$$\text{k} = \frac{Δ σ}{Δ δ} \qquad \text{(5)}$$
where, Δσ is the pressure borne by the TSF soft belt with a specific thickness, and Δδ is the compressive deformation of the TSF soft belt at this pressure;
in the step 3, the total number of the main load-bearing guide rail surfaces is n, Ai represents the application point of the resultant force on each guide rail surface, O represents the rotation center, a system of vector equations for each main load-bearing guide rail surface when the rotation center is located in each region is established according to the triangle rule of vector addition, and in order to make the mathematical model finally established become a statically determinate problem, the number of equations contained in the system is n-1:
$$\vec{{A}_{ι} O} + \vec{O {A}_{ι + 1}} = \vec{{A}_{ι} {A}_{ι + 1}} i = 1 , ⋯ , n - 1 \qquad \text{(6)}$$
a vector is projected to the x and y axes, a and b are respectively the distance of the application point of the resultant force on two guide rail surfaces projected on the y and x axes, and a system of geometrical relationship equations is established according to equation (6):
$$\left\{\begin{matrix}\left|sin {β}_{i} ⋅ {l}_{i} + {λ}_{i} ⋅ sin {β}_{i + 1} ⋅ {l}_{i + 1}\right| = {a}_{i} \\ \left|cos {β}_{i} ⋅ {l}_{i} + {ψ}_{i} ⋅ cos {β}_{i + 1} ⋅ {l}_{i + 1}\right| = {b}_{i}\end{matrix}\right) {λ}_{i} = \left\{- 1 , 1\right\} , {ψ}_{i} = \left\{- 1 , 1\right\} \qquad \text{(7)}$$
based on the above equations, the mathematical model when the rotation center is located in different regions is established;
$$\left\{\begin{matrix}\sum {F}_{X} = 0 \\ \sum {F}_{Y} = 0 \\ \sum \text{M} = 0 \\ \left|sin {β}_{1} ⋅ {l}_{1} + {λ}_{1} ⋅ sin {β}_{2} ⋅ {l}_{2}\right| = {a}_{1} \\ \left|cos {β}_{1} ⋅ {l}_{1} + {ψ}_{1} ⋅ cos {β}_{2} ⋅ {l}_{2}\right| = {b}_{1} \\ ⋮ \\ \left|sin {β}_{n - 1} ⋅ {l}_{n - 1} + {λ}_{n} ⋅ sin {β}_{n} ⋅ {l}_{n}\right| = {a}_{n} \\ \left|cos {β}_{n - 1} ⋅ {l}_{n - 1} + {ψ}_{n} ⋅ cos {β}_{n} ⋅ {l}_{n}\right| = {b}_{n}\end{matrix}\right) \qquad \text{(8)}$$
in the step 4, the limit load-bearing value of each plastic laminated surface is calculated according to the maximum moving speed v
ₘₐₓ of a sliding plate on the y axis and the limiting pν value of the soft belt:
$${{F}^{′}}_{m a x} = p ⋅ S = \frac{p v ⋅ S}{{v}_{m a x}} \qquad \text{(9)}$$
when a pretightening guide rail surface is located on the opposite side of a main load-bearing guide rail surface, as the actual value of resultant force F on the main load-bearing guide rail surface is the sum of a theoretical value and a pretightening force on the corresponding pretightening guide rail surface, and according to the design principle that the pretightening force shall not exceed 0.2 times the limit pressure, the pressure on the main load-bearing guide rail surface is obtained:
$${F}_{m a x} = \left(1 - 0.2\right) {{F}^{′}}_{m a x} \qquad \text{(10)}$$
in summary, the allowable range Φ
ᵢ of the pressure Fᵢ on each guide rail surface is obtained.

10. The unloading method for a gantry-type machining center beam guide rail according to claim 9, wherein in the step 5, a unidirectional unloading force has a great influence on the load-bearing condition of the guide rail in the same direction, but has a small influence on the pressure of the guide rail surface in a different direction; when unloading forces are only in the vertical direction and the horizontal direction, the selection of the unloading forces in the two directions is analyzed independently; in the step 5, if the included angle between the direction of an unloading force and the horizontal surface of an unloading mechanism is less than 90°, the unloading force shall be decomposed in the vertical direction and the horizontal direction:
$$\left\{\begin{matrix}{F}_{s x} = cos {β}_{s} ⋅ {F}_{s} \\ {F}_{s y} = sin {β}_{s} ⋅ {F}_{s}\end{matrix}\right) \qquad \text{(12)}$$
F
ₛₓ and F_{sy} are taken as two unloading forces in different directions, and the mathematical model is established according to the same method.
